(19) United States
(12) Patent Application Publication
(10) Pub. No.: US 2004/0112619 A1
(43) Pub. Date: Jun. 17, 2004

(54) Strap-shaped input device

(75) Inventors: Junichi Inamura, Fukushima-ken (JP); Tadamitsu Sato, Fukushima-ken (JP)

Correspondence Address: Brinks Hofer Gilson & Lione, P.O. Box 10395, Chicago, IL, 60610, US

(73) Assignee: Alps Electric Co., Ltd.

(21) Appl. No.: 10/731,314

(22) Filed: Dec. 9, 2003

(30) Foreign Application Priority Data
Dec. 13, 2002 (JP) 2002-362830

(51) Int. Cl. H02G 7/00

(52) U.S. Cl. 174/40 CC

(57) ABSTRACT

An input device includes a belt-shaped strap section in which leads are buried, and connecting members for connecting the strap section in an annular form. The strap section includes a sheet-shaped membrane having a plurality of input sections, and belt-shaped clamping members that can hermetically sandwich portions of the membrane having the input sections. One end of the membrane extends from end portions of the clamping members to be connected to an external device with one of the connecting members therebetween.

### BACKGROUND OF THE INVENTION

1. Field of the Invention

The present invention relates to an input device, and more particularly, to an input device in which a sheet-shaped membrane can be hermetically sealed in an annular strap section.

2. Description of the Related Art

A known input device is disclosed in, for example, Japanese Unexamined Patent Application Publication No. 2002-27079. The input device has an annular strap section 51 that can be worn around the human neck or the like, as shown in FIG. 22. Earphone cables 52 are extended by a predetermined length from two positions on the upper side of the strap section 51 in the figure. The leading ends of the earphone cables 52 are connected to earphones 53.

The lower side of the annular strap section 51 in the figure is connected with a connecting member 54, and an input section (not shown) is provided in the connecting portion 54. The earphone cables 52 are buried inside the strap section 51 so that they are connected to the input section in the connecting portion 54.

A cable 55 connected to the input section is extended by a predetermined length from the connecting portion 54. The cable 55 includes an audio signal cable and a cable for transmitting signals output from the input section, and a plug (not shown) is connected to an end portion thereof.

In the known input device having such a configuration, when the plug at the end of the cable 55 is inserted in and connected to a jack (not shown) of a portable acoustic device 56, the potable acoustic device 56 can be used inside a pocket of a garment, a bag, or the like in a state in which the strap section 51 is worn around the neck and the earphones 53 are put in the ears of the operator.

By operating the input section of the connecting portion 54, for example, music recorded on a CD and the like can be played back, and the playback can be stopped.

In the above-described known input device, however, for example, when rain falls while the operator is listening to music through the earphones 53 with the strap section 51 worn around the neck outdoors by playing back a CD, water drops may enter the interior of the connecting portion 54, and may cause trouble, for example, the internal input section may be short-circuited.

In order not only to start and stop the playback operation by the portable acoustic device 56, but also to perform a plurality of adjustment operations, such as volume control or balance control, by using the input section provided in the connecting portion 54, a plurality of input sections are needed, and the size of the connecting portion 54 is increased.

Furthermore, since the earphones 53 are combined with the strap section 51 with the earphone cables 52 therebetween, when the operator is not listening to music or the like with the strap section 51 worn around the neck, the earphones 53 detached from the ears hang loose and are cumbersome.

### SUMMARY OF THE INVENTION

The present invention has been made in view of the above-described problems, and the object of the present invention is to provide an input device in which an input section provided in a strap section is reliably made waterproof, and earphones can be detachably connected to the strap section.

In order to achieve the above object, according to one aspect, the present invention provides an input device including a belt-shaped strap section having a lead buried therein, and a connecting member for connecting the strap section in an annular form. The strap section includes a sheet-shaped membrane having a plurality of input sections, and at least one belt-shaped clamping member that can hermetically sandwich portions of the membrane with the input sections. One end of the membrane extends from an end portion of the clamping member to be connected to an external device with the connecting member therebetween.

This allows the external device to be operated through the input sections provided in the strap section. Since the external device held in the bag or the like can be operated without being taken out, the usability is high. Moreover, since the input sections are hermetically sealed by the clamping member, water drops can be prevented from entering the input sections. Accordingly, the input device of the present invention can be used even when rain is falling.

Preferably, the clamping member includes a lead-containing portion in which the lead is buried in the longitudinal direction, and a pair of opposing clamping plates extending along the lead-containing portion to sandwich the membrane in a hermetical manner.

Therefore, it is possible to reliably seal the membrane having the input sections and to make the input sections waterproof.

Preferably, one side of each of the clamping plates is provided integrally with the lead-containing portion, the other sides of the clamping plates are spaced from each other with a predetermined distance, and the membrane is hermetically sandwiched by thermofusing the other sides of the clamping plates.

In this case, the internal membrane can be reliably sealed in a waterproof manner. Moreover, even when the clamping member is folded, the clamping plates will not be separated from each other because they are thermofused.

Preferably, the membrane is formed by folding a comb-shaped sheet substrate to form opposing portions, the input sections include contact portions provided on the opposing portions of the substrate, and an outer peripheral portion of each of the contact portions is overcoated with an insulating resist film to expose a predetermined area.

In this case, the contact portions can be produced easily, and the input sections can be formed with the contact portions facing each other with the resist film used as a spacer. Moreover, the number of components can be reduced. the input section can be used easily.

Preferably, thin portions of the clamping plates corresponding to the contact portions are elastically deformable. This improves the usability of the input sections.

Preferably, the strap section includes further includes another claming member, and the connecting member includes a first connecting member for connecting one-end portions of the clamping members, and a second connecting member for connecting the other-end portions of the clamping members. The strap section is shaped in the annular form by connecting the clamping members with the first and second connecting members.

In this case, two short clamping members are connected in an annular form by the connecting members, and the earphone can be detachably connected to the second connecting member. Therefore, when the strap section is worn around the neck, the earphone may be detached in a non-operation state. This improves the appearance.

Preferably, the lead and the membrane extend from each of the one-end portions of the clamping members and are connected to the first connecting member, and the lead extends from each of the other-end portions of the clamping members and is connected to the second connecting member.

In this case, the input sections provided in the membrane can be connected to the switch member of the first connecting member, and the earphone can be connected to the second connecting member.

Preferably, the first connecting member has a switch member that switches the connection between the external device and the input sections of the membrane.

In this case, the external device and the input sections can be disconnected by operating the switch member. This improves the usability of the input device.

Preferably, the membrane extending from the one ends of the clamping members has a terminal to be connected to an FPC (flexible printed circuit) connector provided in the first connecting member.

Since the input sections can be connected to the external device only by inserting the terminal in the FPC connector, the assembly efficiency is enhanced.

Preferably, the second connecting member has an earphone jack to which an earphone is connected.

In this case, the earphone may be detached from the earphone jack in a non-operation state. This can improve the appearance.

Preferably, the second connecting member has a jack substrate on which the earphone jack is mounted, and hermetically seals the jack substrate therein.

In this case, the interior of the second connecting member is hermetically sealed in a waterproof fashion.

Preferably, an outer peripheral portion of the clamping member is covered with a cover member.

In this case, the appearance of the strap section can be improved, for example, by forming a pattern on the cover members.

Preferably, the cover member has marks corresponding to the input sections. Mark can be easily formed on the cover members by printing or by other means.

Preferably, the strap section is wearable around the neck, and the input sections and the switch member are positioned so as to be operated by the hand when the strap section is worn around the neck with the second connecting member placed on the neck side.

This can improve the usability of the input device.

Further objects, features and advantages of the present invention will become apparent from the following description of the preferred embodiments with reference to the attached drawings.

### BRIEF DESCRIPTION OF THE DRAWINGS

FIG. 1 is an explanatory perspective view of an input device of the present invention;

FIG. 2 is a perspective view of a membrane used in the input device;

FIG. 3 is a perspective view showing a state in which the membrane shown in FIG. 2 is folded;

FIG. 4 is a principal sectional view showing an input section in the input device;

FIG. 5 is an explanatory view showing an example of a clamping member in the present invention;

FIG. 6 is an explanatory view showing a modification of a clamping member;

FIG. 7 is a perspective view showing the assembly of the clamping members;

FIG. 8 is a perspective view showing the assembly of clamping members;

FIG. 9 is a perspective view showing the assembly of the clamping members;

FIG. 10 is a perspective view showing the clamping members in which the membrane is hermetically sealed;

FIG. 11 is an explanatory view of one cover member in the input device;

FIG. 12 is an explanatory view of the other cover member;

FIG. 13 is a perspective view of a case that constitutes a first connecting member in the input device;

FIG. 14 is a perspective view of a key top that constitutes the first connecting member;

FIG. 15 is a perspective view of a substrate that constitutes the first connecting member;

FIG. 16 is an exploded perspective view showing the first connecting member;

FIG. 17 is a perspective view showing an assembly state of the first connecting member;

FIG. 18 is a perspective view of a case that constitutes a second connecting member in the input device;

FIG. 19 is a perspective view of a substrate that constitutes the second connecting member;

FIG. 20 is a perspective view showing a state in which leads are connected to the back side of the substrate shown in FIG. 19;

FIG. 21 is a perspective view showing an assembly state of the second connecting member; and

FIG. 22 is a perspective view of a known input device.

### DESCRIPTION OF THE PREFERRED EMBODIMENTS

An input device according to the present invention will be described below with reference to the attached drawings.

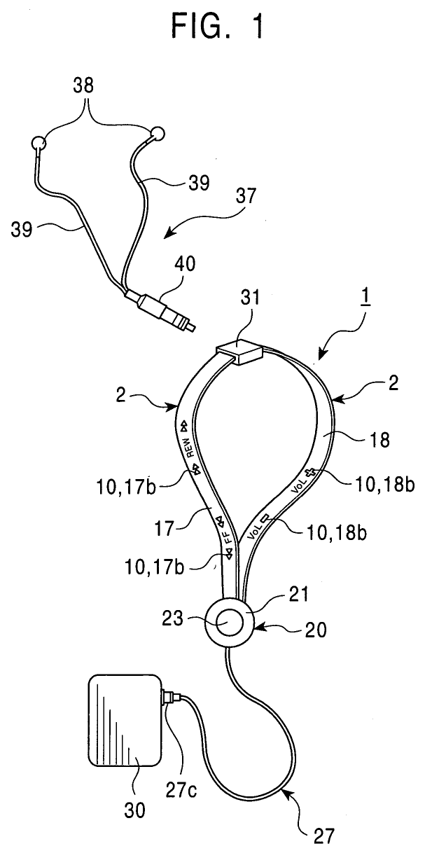

An input device 1 of the present invention is provided with a belt-shaped, flexible, and annular strap section 2 that can be worn around, for example, the human neck (neckworn), as shown in FIG. 1. The strap section 2 contains a sheet-shaped flexible membrane 3 made of a PET film or the like in a hermetically sealed manner.

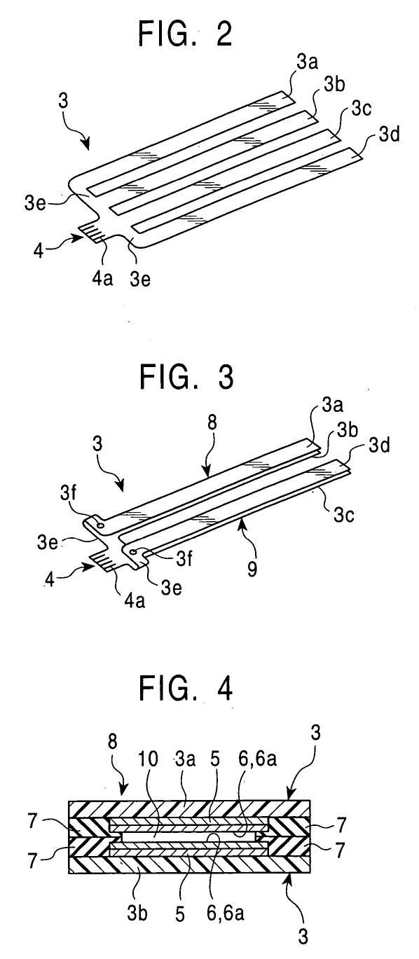

As shown in FIG. 2, the membrane 3 is shaped like a comb in which a bar portion 3e is provided at the left ends in the figure of first to fourth strip-shaped substrates 3a to 3d to connect the substrates 3a to 3d.

A terminal 4 is provided at one end of the membrane 3 to protrude from the bar portion 3e to the left in the figure. The terminal 4 includes a plurality of circuit patterns 4a routed and connected to contact portions 6a of input sections 10, which will be described later, provided on the first to fourth substrates 3a to 3d.

Silver electrodes 5 made of a good conductor film are provided on the surfaces of the first to fourth substrates 3a to 3d to be connected to the circuit patterns 4a of the terminal 4. Resistor layers 6 made of a resistor film are provided on the silver electrodes 5, as shown in FIG. 4.

The peripheral portions of the resistor layers 6 are overcoated with insulating resist films 7 so that predetermined areas are exposed, and the exposed areas serve as contact portions 6a.

A plurality of contact portions 6a are provided on the substrates 3a to 3d at an equal distance from the bar portion 3e.

In such a comb-shaped membrane 3, as shown in FIG. 3, the bar portion 3e is folded to place the first substrate 3a onto the second substrate 3b and to place the fourth substrate 3d onto the third substrate 3c, thereby forming a first substrate unit 8 and a second substrate unit 9.

The first and second substrate units 8 and 9 have bonded portions 3f that are formed by bonding the bar portion 3e, for example, by thermobonding.

The first and second substrate units 8 and 9, herein, only the first substrate unit 8 will be described with reference to FIG. 4. The contact portions 6a provided on the first and second substrates 3a and 3b oppose each other with a predetermined gap therebetween by using the resist films 7 as spacers.

A section at which the contact portions 6a oppose each other serves as an input section 10. By pressing a portion of the first substrate 3a or a portion of the second substrate 3b corresponding to the input section 10, or both portions, the contact portions 6a are brought into contact with each other and electrically connected.

Because of such electric continuity between the contact portions 6a established by operating the input section 10, it is possible, for example, to control the volume of an external device 30 serving as a portable acoustic device, which will be described later, or to perform skipping.

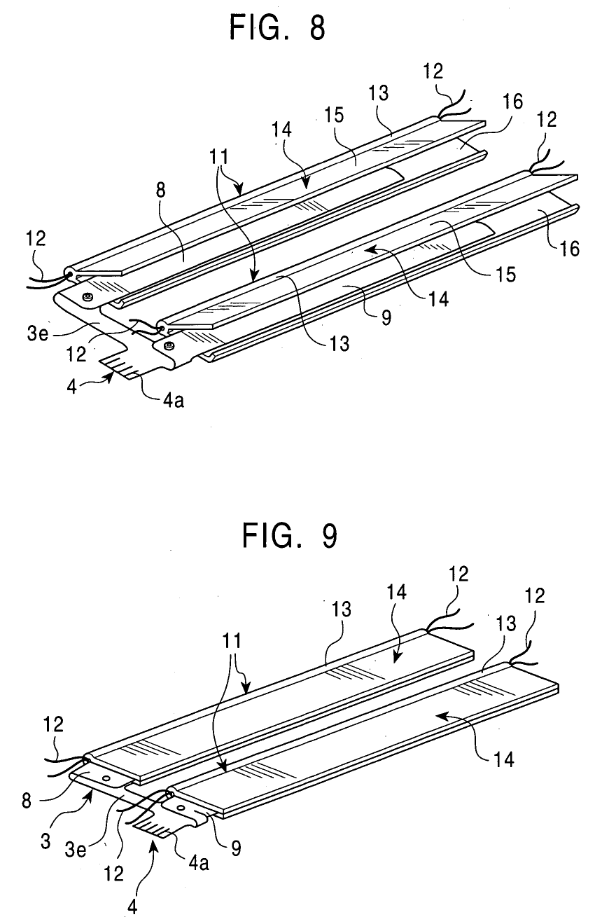

The portions of the first and second substrate units 8 and 9 corresponding to the input section 10, which are formed by folding the substrates 3a to 3d at the bar portion 3e, can be hermetically sealed by being sandwiched by a pair of clamping members 11 shown in FIGS. 8 and 9.

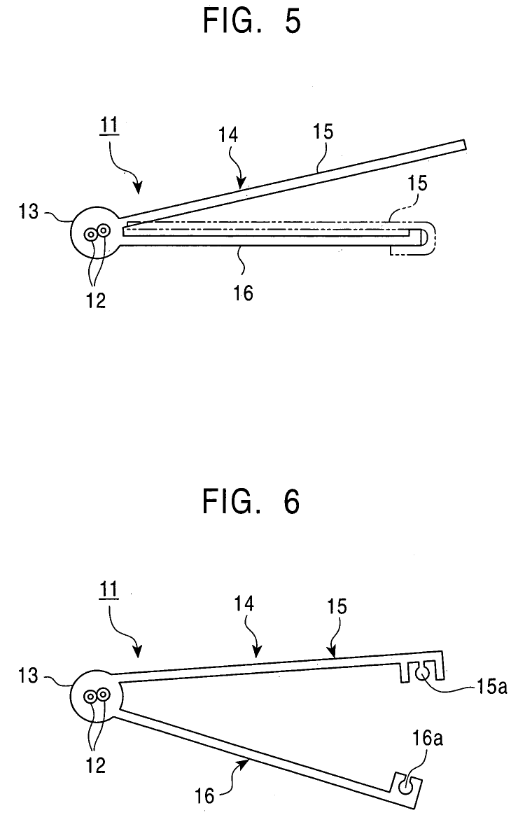

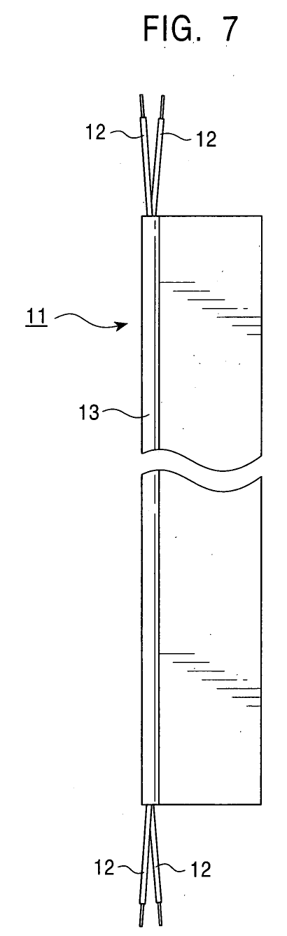

Each of the clamping members 11 is composed of flexible synthetic resin, and is shaped like an elongated belt. As shown in FIGS. 5 to 7, each clamping member 11 has on its left side, a cylindrical lead-containing portion 13 in which leads 12 are buried in the longitudinal direction.

The clamping member 11 also has a membrane-sealing portion 14 along the lead-containing portion 13, in which the first substrate unit 8 or the second substrate unit 9 of the membrane 3 is placed in a hermetically sealed manner.

The membrane-sealing portion 14 includes one and the other clamping plates 15 and 16 opposing each other. As shown in FIGS. 5 and 6, left one-side portions of the clamping plates 15 and 16 are formed integrally with the lead-containing portion 13, and right other-side portions thereof are open and are spaced from each other with a predetermined gap therebetween.

As shown in FIG. 5, one of the clamping plates 15 is longer than the other clamping plate 16. The inner membrane 3 is hermetically sealed by folding the other-side portion of the clamping plate 15, as shown by a two-dot chain line, and thermofusing the other-side portions of the clamping plates 15 and 16.

For this reason, the inner membrane 3 is made waterproof, and droplets of water, such as rain, can be prevented from entering the input section 10 even when the droplets splash on the clamping member 11.

As a modification of the clamping member 11, as shown in FIG. 6, a rib 15a protruding at the other-side portion of one of the clamping plates 15 in parallel with the lead-containing portion 13 may be press-fitted in a groove 16a provided in the other clamping plate 16.

As shown in FIGS. 8 and 9, when the first and second substrate units 8 and 9 of the membrane 3 are placed between one and the other clamping plates 15 and 16 of the open clamping members 11, the leads 12 and the beam portion 3d at one end of the membrane 3 are extended outside the left ends of the clamping members 11. The leads 12 are also extended from the other right ends.

By tightly thermofusing the open clamping plates 15 and 16, the portions of the membrane 3 having the input sections 10 are hermetically sealed.

Consequently, the portions of the membrane 3 having the input sections 10 are made waterproof, and drops of water, such as rain, can be prevented from entering the input sections 10.

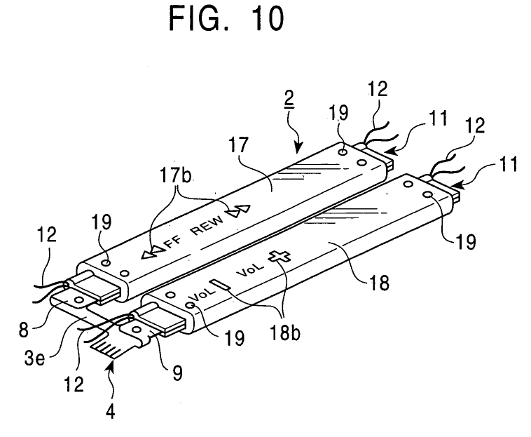

The outer peripheral portions of the clamping members 11 having the membrane 3 sealed therein are covered with cover members 17 and 18, as shown in FIG. 10. The cover members 17 and 18 are made of cloth, a flexible resin material, or the like, and the length thereof is equal to or slightly smaller than that of the clamping members 11.

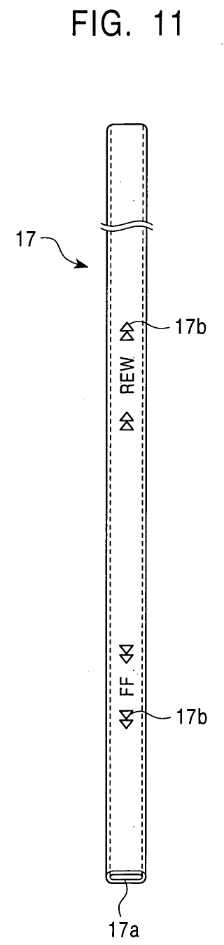

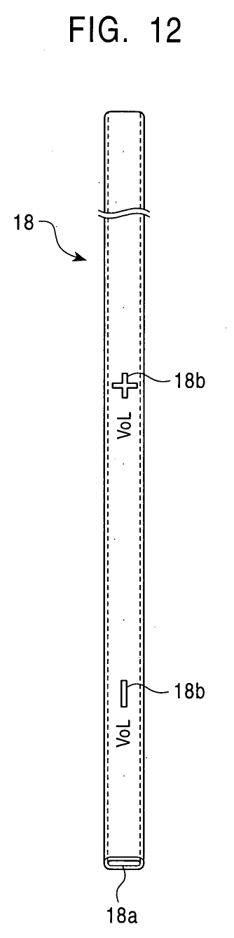

The cover members 17 and 18 are provided with narrow insertion holes 17a and 18a through which the clamping members 11 having the membrane 3 therein extend, as shown in FIGS. 11 and 12.

The cover members 17 and 18 are also provided with marks 17b and 18b shown in FIGS. 11 and 12 that are formed, for example, by printing on the surfaces thereof close to the lower left ends.

The marks 17b and 18b are provided on both surfaces or on the outer surfaces of the cover members 17 and 18.

When the outer peripheral portions of the clamping members 11 having the membrane 3 therebetween are covered with the cover members 17 and 18 by inserting the clamping members 11 in the insertion holes 17a and 18a, the input sections 10 are positioned corresponding to the marks 17b and 18b.

Support holes 19 are provided through both end portions of the cover members 17 and 18, as shown in FIG. 10. Through holes (not shown) are also provided in the clamping members 11 and the first and second substrate units 8 and 9 corresponding to the support holes 19.

Support pins 21f of a first connecting member 20 and support pins 32d of a second connecting member 31, which will be described later, are passed through the support holes 19, so that both end portions of the clamping members 11 can be connected.

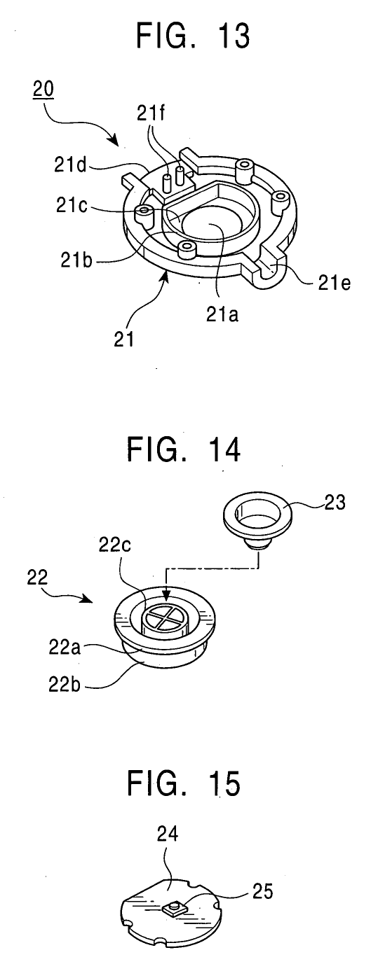

The left end portions of the above-described clamping members 11 shown in FIG. 10 are connected to the first connecting member 20. The first connecting member 20 includes a case 21 having a substantially circular outline, as shown in FIGS. 13 to 17.

As shown in FIG. 13, a through hole 21a is provided at almost the center of the back side of the case 21. A substantially D-shaped wall 21b is provided around the through hole 21a, and a recess 21c having a predetermined depth is provided inside the wall 21b.

A first holding groove 21d is provided on the inner left side of the case 21 in the figure to hold one-end portions of the clamping members 11 covered with the cover members 17 and 18 and placed one on another. A second holding groove 21e is provided on the right front side in the figure of the case 21 opposing the first holding groove 21d to hold a cable 27 which will be described later.

Two support pins 21f having a predetermined height protrude at the first holding groove 21d of the case 21.

A key top 22 shown in FIG. 14 can be placed on the front side of the case 21 opposite to the recess 21c. The key top 22 includes a flange portion 22a having a substantially circular outline, and a switch-operating portion 22b to be disposed in the through hole 21a. The flange portion 22a has a rubber fitting portion 22c. A waterproof rubber 23 is press-fitted in the rubber fitting portion 22c so that the front side of the case 21 is made waterproof.

An insulating substrate 24 shown in FIG. 15 can be placed on the wall 21b on the back side of the case 21 shown in FIG. 13. A pushbutton switch member 25, such as a tactile switch, is provided at almost the center of one side of the substrate 24. An FPC connector 26 is connected and fixed to the other side of the substrate 24, for example, by soldering, and the terminal 4 of the membrane 3 can be plugged in the FPC connector 26.

A plurality of lead-soldering portions 24a and cable-soldering portions 24b are also provided on the other side of the substrate 24.

When such a substrate 24 is placed on the wall 21b with the FPC connector 26 facing upward, as shown in FIG. 17, the switch member 25 is disposed at the through hole 21a. The switch member 25 is allowed to be turned on and off by the switch operating portion 22b of the key top 22.

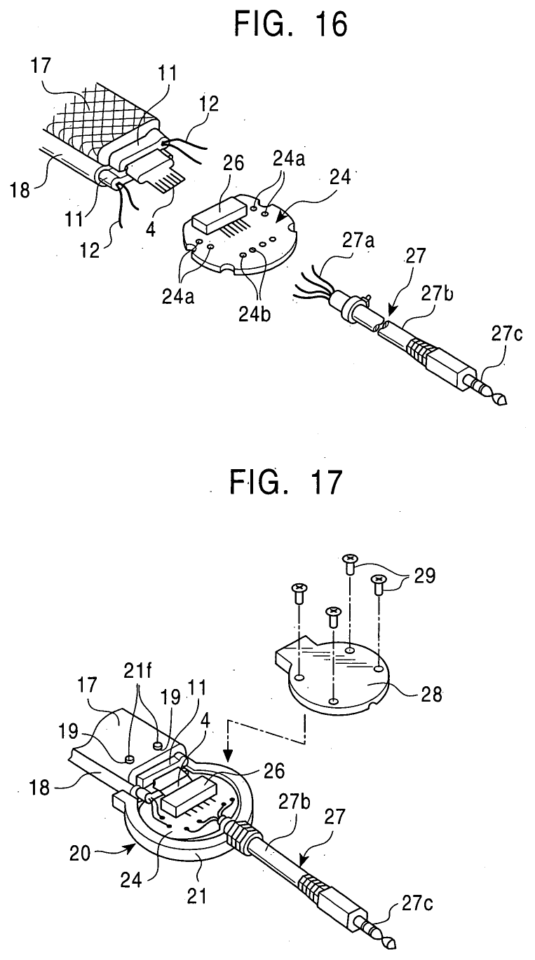

A cable shown in FIG. 16 can be soldered to the cable soldering portions 24b of the substrate 24. A plug 27c is connected to the cable 27 through connecting portions 27a that can be soldered to the cable soldering portions 24b, and a cable portion 27b having a predetermined length.

As shown in FIG. 17, a back lid 28 is provided to cover the back side of the substrate 24. The back lid 28 is fixed to the case 21 with a plurality of screws 29, so that the back side of the case 21 can be made waterproof by a waterproof packing that is not shown.

That is, the interior of the case 21 of the first connecting member 20 is made waterproof by the waterproof rubber 23 and the back lid 28.

In order to connect the one-end portions of the clamping members 11 with such a first connecting member 20, first, the one-end portions of the clamping members 11 are placed one on another, and are put in the first holding groove 21d. Then, the terminal 4 is inserted in the FPC connector 26, and the support holes 19 are fitted on the support pins 21f, thereby preventing the one-end portions of the clamping members 11 from falling off the case 21.

The leads 12 extending from the one-end portions of the clamping members 11 are connected to the lead soldering portions 24a by soldering.

The connecting portions 27a of the cable 27 are soldered to the cable soldering portions 24b. After that, the one-end portions of the clamping members 11 can be connected with the first connecting member 20 by closing the back side of the case 21 by the back lid 28.

The cable 27 connected to the first connecting member 20 can be connected to an external device 30 such as a portable acoustic device, for example, by inserting the plug 27c in a jack (not shown) of the external device 30, as shown in FIG. 1.

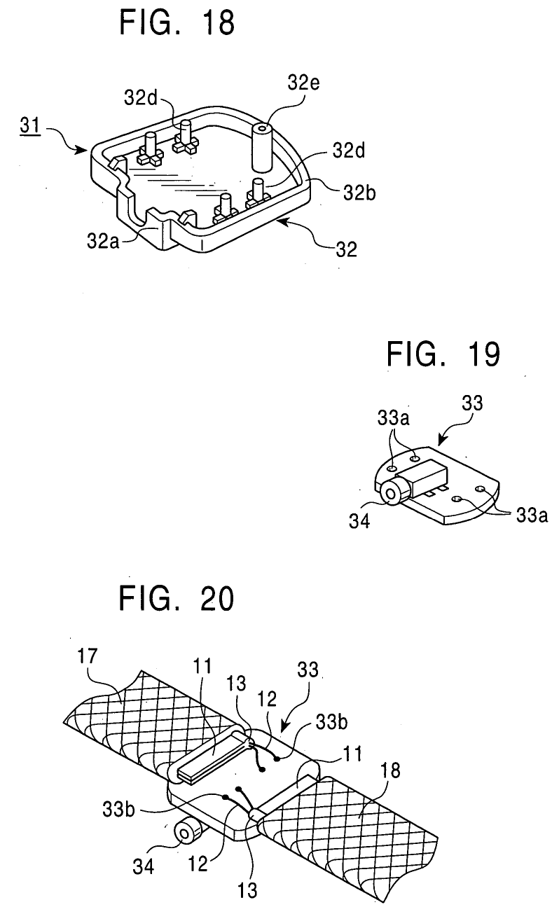

The right other-end portions of the clamping members 11 shown in FIG. 10 are connected to the second connecting member 31. The second connecting member 31 includes a case 32 having a substantially rectangular outline, as shown in FIGS. 18 to 21.

As shown in FIG. 18, the case 32 has a jack support portion 32a at one end, and is surrounded by a peripheral wall 32b having a predetermined height.

The case 32 is shielded by a bottom wall 32c at the bottom, and is open at the top. Four support pins 32d and a support rod 32e having predetermined heights protrude from the bottom wall 32c.

A substrate 33 having a substantially oval outline can be attached to the case 32. The substrate 33 has support holes 33a that can be fitted on the support pins 32d of the case 32.

An earphone jack 34 is provided on the center of one side of the substrate 33, in which a plug 40 of an earphone 37, which will be described later, can be inserted. The earphone jack 34 is soldered to a soldering through hole (not shown) provided on the substrate 33.

Soldering through holes 33b are provided on the other side of the substrate 33 with the earphone jack 34 disposed on the lower side, as shown in FIG. 20. The leads 12 extending from the other-end portions of the clamping members 11 can be soldered to the soldering through holes 33b.

When the substrate 33 to which the leads 12 are soldered is placed inside the peripheral wall 32b of the case 32 in a state in which the earphone jack 34 is disposed on the lower side, the earphone jack 34 is placed at the jack support portion 32a, and is positioned inside the case 32 with the support pins 32d fitted in the support holes 33a, as shown in FIG. 20.

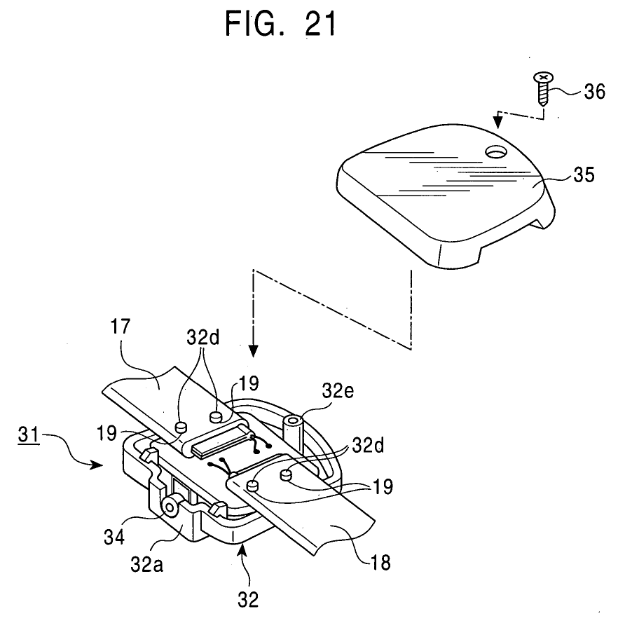

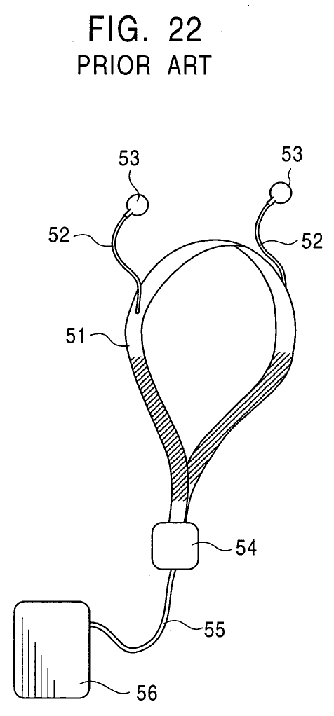

As shown in FIG. 21, a cover 35 is attached to the case 32 with a screw 36 to close the open top of the case 32.

Consequently, the interior of the case 32 in which the substrate 33 is positioned by the support pins 32d is made waterproof with a waterproof packing (not shown).

The above-described clamping members 11 covered with the cover members 17 and 18 are connected to the first connecting member 20 at one end, and to the second connecting member 31 at the other end, thereby making the strap section 2 annular.

The earphone 37 can be connected to the earphone jack 34 of the second connecting member 31, as shown in FIG. 1. The earphone 37 includes a pair of earphone portions 38, cable portions 39 connected to the earphone portions 38, and an earphone plug 40 that are connected to the cable portions 39 and that are capable of being inserted in the earphone jack 34 of the second connecting member 31.

The annular strap section 2 can be worn around the neck of the operator. When the strap section 2 is worn so that the second connecting member 31 is placed on the neck side of the operator, the first connecting member 20 and the input sections 10 (marks 17b and 18b) are disposed on the chest side of the operator. Therefore, the switch member 25 of the first connecting member 20 and the input sections 10 of the strap section 2 are placed in an area such that they can be operated by the hand of the operator.

That is, the strap section 2 is wearable around the neck. When the strap section 2 is worn around the neck with the second connecting member 31 on the neck side, the input sections 10 and the switch member 25 are placed in an area such that they can be operated by hand.

Operation of such an input device 1 of the present invention will be described. First, the annular strap section 2 is worn around the neck of the operator so that the second connecting member 31 having the earphone jack 34, in which the earphone plug 40 of the earphone 37 is fitted, is placed at the back of the neck of the operator.

The first connecting member 20 is thereby placed adjacent to the chest of the operator, and the input sections 10 of the strap section 2 are also placed at the positions above the first connecting member 20 such that they can be operated by the hand of the operator. In this case, the external device is held in a pocket, a bag, or the like.

By pressing the waterproof rubber 23 disposed on the front side of the first connecting member 20, the switch member 25 is turned on to drive or stop the external device 30. When the external device 30 is, for example, a portable acoustic device for a CD, the playback of the CD can be started or stopped by turning the switching member 25 on and off.

By pinching one of the marks 17b between the fingers, the input section 10 corresponding to the mark 17b is operated, for example, to control the volume. By operating the other mark 18b, for example, skipping or back-skipping can be performed.

Since the strap section 2 has a plurality of input sections 10 in the input device 1, a plurality of operations can be performed by operating the input sections 10 without taking the external device 30 out of the bag or the like. This provides high usability.

While the strap section 2 is made annular by connecting the end portions of the clamping members 11 by the first and second connecting members 20 and 31 in the above embodiment, in another embodiment, it may be made annular by placing both end portions of a single elongated clamping member (not shown) one on another and connecting the end portions by a single connecting member.

In this case, although not shown, the two earphone portions 38 of the earphone may be connected to the leads 12 extended from the right and left portions of the annular strap section. In such an input device (not shown) of another embodiment, the second connecting member 31 described in the above embodiment is unnecessary, and the number of components can be reduced.

While the clamping members 11 having the membrane 3 sandwiched therein are covered with the cover members 17 and 18 in the above description, they may be exposed without the cover members 17 and 18. In such an input device, the marks 17b and 18b may be provided in the form of projections or pits simultaneously with shaping of the clamping members 11. By making the marks 17b and 18b in the form of projections or pits, the operator can operate the input sections without seeing the marks 17b and 18b.

While the present invention has been described with reference to what are presently considered to be the preferred embodiments, it is to be understood that the invention is not limited to the disclosed embodiments. On the contrary, the invention is intended to cover various modifications and equivalent arrangements included within the spirit and scope of the appended claims. The scope of the following claims is to be accorded the broadest interpretation so as to encompass all such modifications and equivalent structures and functions.

What is claimed is:

1. An input device comprising:
a belt-shaped strap section having a lead buried therein; and
a connecting member for connecting the strap section in an annular form, wherein the strap section comprises:
a sheet-shaped membrane having a plurality of input sections; and
a belt-shaped clamping member that hermetically sandwiches portions of the membrane having the input sections, and
wherein one end of the membrane extends from an end portion of the clamping member to be connected to an external device with the connecting member therebetween.

2. An input device according to claim 1, wherein the clamping member comprises:
a lead-containing portion in which the lead is buried in the longitudinal direction; and
a pair of opposing clamping plates extending along the lead-containing portion to hermetically sandwich the membrane.

3. An input device according to claim 2, wherein one side of each of the clamping plates is provided integrally with the lead-containing portion, the other sides of the clamping plates are spaced from each other with a predetermined distance, and the membrane is hermetically sandwiched by thermofusing the other sides of the clamping plates.

4. An input device according to claim 2 or 3, wherein the membrane hermetically sandwiched between the clamping plates is formed by folding a comb-shaped sheet substrate to form opposing portions, the input sections include contact portions provided on the opposing portions of the substrate, and an outer peripheral portion of each of the contact portions is overcoated with an insulating resist film to expose a predetermined area.

5. An input device according to claim 4, wherein thin portions of the clamping plates corresponding to the contact portions are elastically deformable.

6. An input device according to claim 1, wherein the strap section further comprises another claming member, the connecting member includes a first connecting member for connecting one-end portions of the clamping members, and a second connecting member for connecting the other-end portions of the clamping members, and the strap section is shaped in the annular form by connecting the clamping members with the first and second connecting members.

7. An input device according to claim 6, wherein the lead and the membrane extend from each of the one-end portions of the clamping members and are connected to the first connecting member, and the lead extends from each of the other-end portions of each of the clamping members and is connected to the second connecting member.

8. An input device according to claim 6, wherein the first connecting member has a switch member that switches the connection between the external device and the input sections of the membrane.

9. An input device according to claim 6, wherein the membrane extending from the one end of each of the clamping members has a terminal to be connected to a flexible printed circuit connector provided in the first connecting member.

10. An input device according to claim 6, wherein the second connecting member has an earphone jack to which an earphone is connectable.

11. An input device according to claim 10, wherein the second connecting member has a jack substrate on which the earphone jack is mounted, and hermetically seals the jack substrate therein.

12. An input device according to claim 1, wherein an outer peripheral portion of the clamping member is covered with a cover member.

13. An input device according to claim 12, wherein the cover member has marks corresponding to the input sections.

14. An input device according to claim 8, wherein the strap section is wearable around the neck, and the input sections and the switch member are positioned so as to be operated by hand when the strap section is worn around the neck with the second connecting member placed on the neck side.
